(19) United States
(12) Patent Application Publication
(10) Pub. No.: US 2019/0184815 A1
(43) Pub. Date: Jun. 20, 2019

(54) MULTI-PART INJECTION-MOLDED MULTI-CHAMBER PLASTIC TANK HAVING AN OBLIQUE JOINING SURFACE

(71) Applicant: Röchling Automotive SE & Co. KG, Mannheim (DE)

(72) Inventor: Thomas Nagel, Osaka (JP)

(21) Appl. No.: 16/222,491

(22) Filed: Dec. 17, 2018

(30) Foreign Application Priority Data
Dec. 18, 2017 (DE) 10 2017 223 124.6

(51) Int. Cl. B60K 15/03; B29D 22/00

(52) U.S. Cl. CPC B60K 15/03177; B29D 22/003; F01N 3/2066; B60K 2015/03032; F01N 2610/1406; B60K 2015/03493

(57) ABSTRACT

A multi-chamber plastic tank, in particular for a motor vehicle, encompasses at least two reservoir chambers, fluid-mechanically separated from one another, which are each mutually independently fillable with liquid and from each of which liquids stored therein are mutually independently non-mixingly withdrawable, the multi-chamber plastic tank including a plurality of injection-molded plastic tank components that are intermaterially connected to one another along a joining surface, provision is made that with regard to the final operationally ready installation position of the multi-chamber plastic tank, at least one joining surface is inclined, relative to a reference plane orthogonal to the direction of gravity, in such a way that it is neither parallel nor orthogonal to the reference plane.

The present invention relates to a multi-chamber plastic tank, in particular for a motor vehicle, encompassing at least two reservoir chambers, fluid-mechanically separated from one another, which are each mutually independently fillable with liquid and from each of which liquids stored therein are mutually independently non-mixingly withdrawable, the multi-chamber plastic tank comprising a plurality of injection-molded plastic tank components that are intermaterially connected to one another along a joining surface.

### BACKGROUND OF THE INVENTION

A multi-chamber plastic tank of this species is known from DE 10 2014 209 380 A1. With this multi-chamber plastic tank, which serves to store both diesel fuel and, separately therefrom, aqueous urea solution for selective catalytic reduction, the chamber receiving the urea solution is embodied as a protuberance of a tank component, which protuberance extends from a wall portion forming a bottom of the diesel reservoir chamber, into the volume occupied by the multi-chamber plastic tank, as far as the tank lid constituting the upper delimiting wall of the multi-chamber plastic tank.

The known multi-chamber plastic tank is constituted from three tank components that can be formed by plastic injection molding. Each joining surface along which each two plastic tank components of the known multi-chamber plastic tank are connected to one another is a joining plane that is oriented parallel to a reference plane that is oriented, with regard to the operationally ready installation position of the multi-chamber plastic tank, orthogonally to the direction of gravity and thus parallel to a liquid level that forms in the reservoir chambers of the multi-chamber plastic tank when partly filled.

The aforementioned reference plane will be utilized in order to simplify the description of the multi-chamber plastic tank of the present invention, since as a rule a multi-chamber plastic tank is of course to be regarded as being oriented in its operationally ready installation position. In the interest of easier drainage of individual, or all, reservoir chambers, their bottoms can be embodied conically or, in generally, taperingly toward a lowest withdrawal opening. The lids of the reservoir chambers may be irregularly contoured as a result of the possibly restricted installation space available in the operationally ready installation position. A similar consideration applies to side walls of the reservoir chambers or of the multi-chamber plastic tank as a whole. When the bottom and/or lid of a reservoir chamber is or encompasses a flat surface that is oriented orthogonally to the direction of gravity when the multi-chamber plastic tank is in the operationally ready installation position, that flat bottom and/or that flat lid can serve as a reference plane. The flat bottom and/or flat lid can comprise stiffening ribs and the like.

### SUMMARY OF THE INVENTION

An object of the present invention is to improve the manufacturability, in terms of injection-molding engineering, of the multi-chamber plastic tank of the species.

This object is achieved according to the present invention by a multi-chamber plastic tank of the kind recited previously in which, with regard to the final operationally ready installation position of the multi-chamber plastic tank, at least one joining surface is inclined, relative to the reference plane orthogonal to the direction of gravity, in such a way that it is neither parallel nor orthogonal to the reference plane.

Because tanks as a rule are oriented in terms of their design, regardless of whether they encompass only one or several chambers, with respect to the location of the direction of gravity in their subsequent installation position, i.e. the location of a liquid level in the tank, the concept of a joining surface inclined with reference to the aforesaid reference plane appears at first unorthodox, since for the observer, the joining surface thereby created passes obliquely through the multi-chamber plastic tank.

The joining surface that is oblique with respect to the reference plane results, however, in surprisingly wide leeway in terms of the physical design of the multi-chamber plastic tank. This is because an undesired locally different distribution of plastic can be avoided even in when reservoir chambers of the multi-chamber plastic tank are of very different sizes, thus ensuring uniform and complete filling of an injection molding cavity. For example, fastening configurations embodied integrally with a plastic tank component, for fastening the multi-chamber plastic tank to a structure that carries it during operation, in particular to a motor vehicle, can be embodied with a locally irregular distribution on the plastic tank component without thereby causing the overall distribution of plastic compound for manufacturing the plastic tank component to be undesirably inhomogeneous.

In addition, as a result of the initially simple-looking feature of an oblique position of a joining surface, the relative mutual spatial arrangement of two or more reservoir chambers can be selected almost arbitrarily. The size relationships among different reservoir chambers are also freely selectable. Specifically with the preferred application of a multi-chamber plastic tank to store diesel fuel on the one hand and aqueous urea solution on the other hand in a vehicle, the reservoir volume for diesel fuel is usually considerably greater than for urea solution.

A plurality of fastening configurations are therefore preferably embodied on at least one plastic tank component integrally with the remainder of the plastic tank component.

Preferably at least one plastic tank component, particularly preferably all plastic tank components, of the multi-chamber plastic tank are embodied integrally in order to minimize the number of components necessary in order to constitute the multi-chamber plastic tank.

Wall portions of the multi-chamber plastic tank which delimit a volume of a reservoir chamber are preferably embodied in single-layer fashion, so that the plastic tank components can be manufactured with the shortest possible cycle time in large quantities per unit time.

In principle, the at least one joining surface can be a joining surface curved three-dimensionally in space. This can, however, complicate handling of the individual plastic tank components and, in particular, welding thereof. In the interest of simplifying the manufacturing process of the multi-chamber plastic tank under discussion here, at least one joining surface is therefore a joining plane. The tank components to be joined along the joining plane are thereby displaceable relative to one another in a direction parallel to the joining plane, and thus alignable. Although this need not necessarily be so, when more than one joining surface is provided preferably all the joining surfaces are joining planes.

Be it noted that the term “intermaterial connection” referred to above refers to adhesive bonding and/or welding; welding of the plastic tank components to one another is preferred because of the greater permanent sealing thereby obtainable.

Preferably the multi-chamber plastic tank is constructed in such a way that at least one bottom of a reservoir chamber, preferably all bottoms of all reservoir chambers, are respectively constituted from a one-piece component portion. Leakage from, and thus component failure of, that portion of a reservoir chamber which is wetted by liquid during operation most frequently and for the longest time can thereby be avoided. The provision of a joint always carries a residual risk of a possible leak. A one-piece embodiment of the lid or lids is also preferred for a lid of a reservoir chamber, preferably for all lids of all reservoir chambers, of the multi-chamber plastic tank. One-piece embodiment of a reservoir chamber bottom, optionally also of a reservoir chamber lid, can be maximized by the fact that the at least one joining surface is inclined by between 5° and 50°, preferably approximately 5° to 40°, with respect to the reference plane. The joining surface, in particular in the form of a joining plane, can then extend exclusively in the side walls that proceed between the reservoir chamber bottom and reservoir chamber lid.

Thanks to the oblique arrangement of the joining surface, in particular joining plane, simplified installation can be achieved by the fact that on the one hand a partition separating two reservoir chambers from one another, and on the other hand the joining surface, do not constitute a common surface, in particular a common plane. Preferably the partition encloses with the reference plane a different angle than does the joining surface.

When the partition is inclined more closely toward the reference plane than toward a plane orthogonal to the reference plane, the inclination angle existing between the partition and reference plane is preferably smaller than the inclination angle existing between the reference plane and joining surface. In a preferred embodiment with a great deal of design freedom, a partition between two reservoir chambers is particularly preferably parallel to the reference plane.

When the partition is closer to a plane orthogonal to the reference plane than to the reference plane itself, however, the partition plane preferably encloses a larger angle with the reference plane than does the joining surface. Particularly preferably, in this case the partition is orthogonal to the reference plane.

Even greater design freedom can be obtained by the fact that the multi-chamber plastic tank comprises more than one joining surface. As a rule, the multi-chamber plastic tank comprises a number of plastic tank components which is greater by one than the number of joining surfaces for connecting the plastic tank components, preferably pairwise, to one another.

According to a preferred refinement of the present invention, at least two joining surfaces can each be inclined with respect to the reference surface in such a way that they are neither parallel nor orthogonal to the reference plane, the at least two joining surfaces enclosing an angle between one another. Alternatively or additionally, at least two mutually parallel joining surfaces can each be inclined with respect to the reference surface in such a way that they are neither parallel nor orthogonal to the reference plane.

A particularly advantageous embodiment of a multi-chamber plastic tank according to the present invention, having a great deal of design freedom in terms of the sizes and relative positions of the individual plastic tank-components, comprises at least three plastic tank components, of which two plastic tank components are embodied in hood-shaped fashion as hood components, and of which only one plastic tank component comprises, as a partition component, a partition separating different reservoir chambers from one another. The partition component encompassing only the complete partition can be completed by simply placing the hood components thereonto and by intermaterial connection, in particular welding, thereto in order to yield the multi-chamber plastic tank. In the interest of simple manufacture and installation, the multi-chamber plastic tank encompasses exactly three injection-molded plastic tank components defining its tank volume.

In principle, consideration can be given to placing one hood component onto or against the partition and connecting it thereto. Preferably, however, the partition component comprises the partition and at least one wall portion, projecting from the partition, for connection to a hood component. With the wall portion projecting from the partition, onto whose exposed edge, located remotely from the partition, a likewise exposed edge of the hood component is placeable, a defined joining point for connecting the partition component and hood component is specified.

Consideration can also be given to placing two or more hood components onto the partition component on the same side thereof, and connecting them thereto. This limits the physical configurability of a multi-chamber plastic tank thereby obtainable, however, since proceeding from the partition component, the reservoir chambers constituted by different hood components are located adjacently to one another and therefore share the base area furnished by the partition component. Greater design freedom can be achieved by the fact that the partition component comprises, on both sides of the partition, a respective wall portion projecting therefrom, each one for connection to a different hood component. Two hood components, preferably the only two hood components, are thus placed onto the partition component on different sides thereof, and connected thereto.

Each hood component preferably participates in the constitution of only one reservoir chamber. The partition component participates in the constitution of at least two reservoir chambers.

For space-saving configuration of the multi-chamber plastic tank, a partition is wetted during operation by different liquids on both sides.

According to a further preferred embodiment, a multi-chamber plastic tank can comprise an upper shell and a lower shell, constituting plastic tank components, which together form the multi-chamber plastic tank, the upper shell encompassing the entire tank lid, a part of the side walls, and a part of at least one partition, and the lower shell encompassing the entire tank bottom, a part of the side walls, and a part of at least one partition.

Functional components, for example a fill level sensor, a temperature sensor, a heating device, a withdrawal pump, and/or a quality sensor for detecting a quality of a liquid stored in a reservoir chamber, can be installable onto the multi-chamber plastic tank, if desired as a prefabricated modular subassembly.

The present invention furthermore relates to a motor vehicle having a multi-chamber plastic tank embodied as described above. The motor vehicle is to be considered as being on a flat, horizontal substrate in the operationally ready state.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWING

The invention may take physical form in certain parts and arrangement of parts, a preferred embodiment of which will be described in detail and illustrated in the accompanying drawing which form a part hereof and wherein:

FIG. 1 is a schematic side view of a first embodiment of a multi-chamber plastic tank of the present invention;

FIG. 2 shows the schematic side view of FIG. 1, the multi-chamber plastic tank being separated along its joining plane into its two plastic tank components; and

FIG. 3 is a schematic side view of a second embodiment of a multi-chamber plastic tank of the present invention.

### DESCRIPTION OF PREFERRED EMBODIMENTS

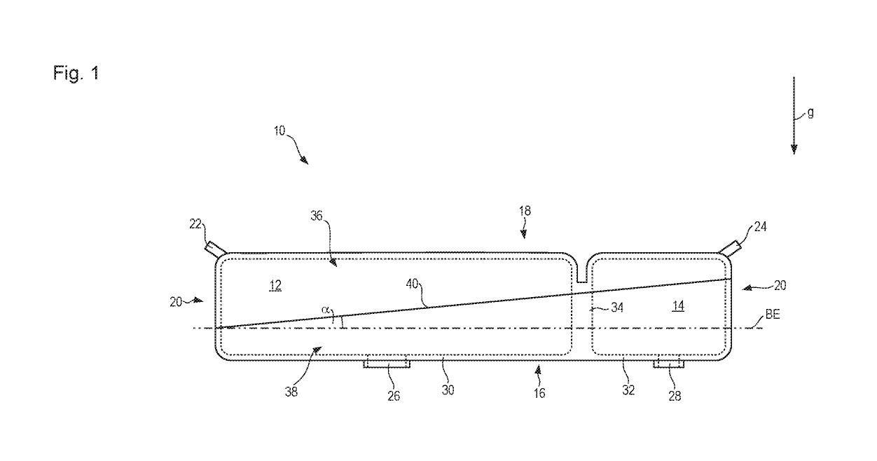

Referring now to the drawing wherein the showings are for the purpose of illustrating preferred and alternative embodiments of the invention only and not for the purpose of limiting the same, FIG. 1 shows a first embodiment according to the present invention of a multi-chamber plastic tank that is designated in general as 10. Multi-chamber plastic tank 10 encompasses a larger reservoir chamber 12 and, entirely fluid-mechanically separated therefrom, a smaller reservoir chamber 14. As the names indicate, reservoir chamber 12 has a greater capacity than reservoir chamber 14. In the example depicted, multi-chamber plastic tank 10 is intended for use in a motor vehicle, reservoir chamber 12 being embodied to receive, store, and deliver diesel fuel, and reservoir chamber 14 being embodied to receive, store, and deliver aqueous urea solution. The aqueous urea solution serves for exhaust emissions control in a manner known per se, so that oxides of nitrogen can be selectively reduced in the exhaust system of the motor vehicle by injecting the urea solution thereinto.

Plastic tank 10 comprises a tank bottom 16, a tank lid 18, and side walls 20 that connect tank bottom 16 and tank lid 18 to one another.

Reservoir chambers 12 and 14 are fillable separately from one another with respective liquids via respective filler tubes 22 and 24. Liquids introduced into reservoir chambers 12 and 14 can be respectively withdrawn therefrom, mutually independently, through corresponding withdrawal openings 26 and 28. In the schematic depiction, withdrawal openings 26 and 28 are usefully located in tank bottom 16, which is both bottom 30 of reservoir chamber 12 and bottom 32 of reservoir chamber 14.

The volumes of reservoir chambers 12 and 14 are completely separated from one another by a vertical partition 34, i.e. one that is parallel to direction of gravity g in the operationally ready final position of plastic tank 10 shown in FIG. 1. Liquids introduced into the respective reservoir chambers 12 and 14 remain stored therein unmixed, and can be withdrawn unmixed from reservoir chambers 12 and 14.

A reference plane BE orthogonal to direction of gravity g serves to simplify the description of the present invention. During operation of multi-chamber plastic tank 10, a respective liquid level will form parallel to reference plane BE in the partly filled reservoir chambers 12 and 14.

Leaving aside further functional components and assemblies that do not determine the tank volume and are to be installed onto it, such as pumps, fill level measurement devices, temperature measurement devices, and the like, plastic tank 10 is constituted by an upper shell 36 and a lower shell 38 constituting plastic tank components of plastic tank 10. Upper shell 36, injection-molded in one piece, encompasses the entire tank lid 18, while lower shell 38, injection-molded in one piece, encompasses the entire tank bottom 16. Portions of side walls 20 and of partition 34 extend respectively away from tank bottom 16 and tank lid 18.

Upper shell 36 and lower shell 38 are manufactured by injection molding as lightweight single-layer plastic components, and are connected to one another along a joining surface, preferably embodied as joining plane 40, to yield multi-chamber plastic tank 10.

Upper shell 36 and lower shell 38 are preferably welded to one another, in particular by ultrasonic welding.

Joining plane 40 extends orthogonally to the drawing plane of FIG. 1, but encloses an angle α with reference plane BE and is inclined, i.e. is neither parallel nor orthogonal, relative thereto. In the example depicted in FIG. 1, the angle α is approximately 10°, that value being recited merely by way of example.

As a result of the inclination of joining plane 40 with respect to reference plane BE, a particularly homogeneous material distribution can be achieved locally over the entirety of the respective shells (upper shell 36 and lower shell 38), with the result that process reliability upon injection molding of upper shell 36 and lower shell 38 can be considerably enhanced.

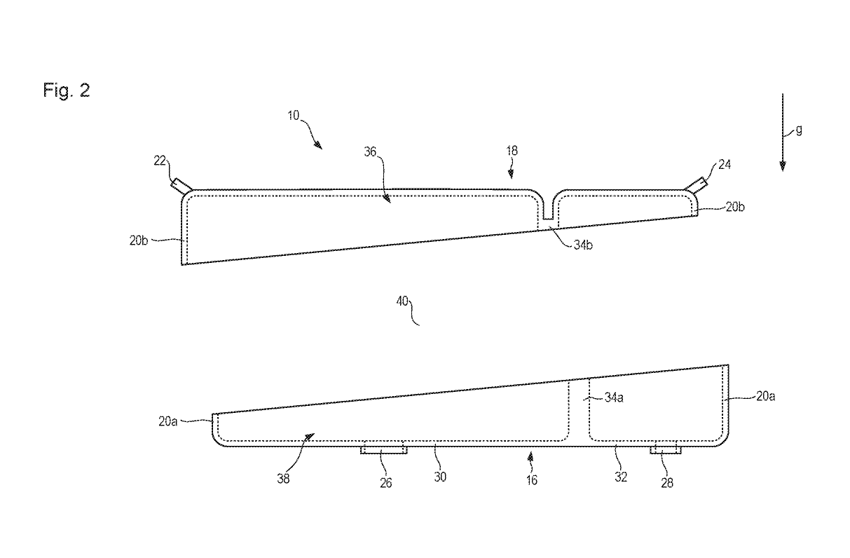

In the exemplifying embodiment of FIGS. 1 and 2, each injection-molded plastic tank component 36 and 38 encompasses portions of all the reservoir chambers 12 and 14. Portions of configurations of multi-chamber plastic tank 10, which are available as operationally ready configurations only after upper shell 36 and lower shell 38 are connected to one another, are identified in FIG. 2 on the respective plastic tank components 36 and 38 with a lower-case “a” for lower shell 38 and with a lower-case “b” for upper shell 36.

Assuming merely for illustrative purposes that the tank components are manufactured in their installation location orientations shown in FIGS. 1 and 2, the unmolding direction in which plastic tank components 36 and 38 are withdrawn from their respective injection molding tools is parallel to direction of gravity g.

In the exemplifying embodiment of FIGS. 1 and 2, the two reservoir chambers 12 and 14 are arranged next to one another, i.e. at approximately the same geodetic elevation in their operationally ready installation position.

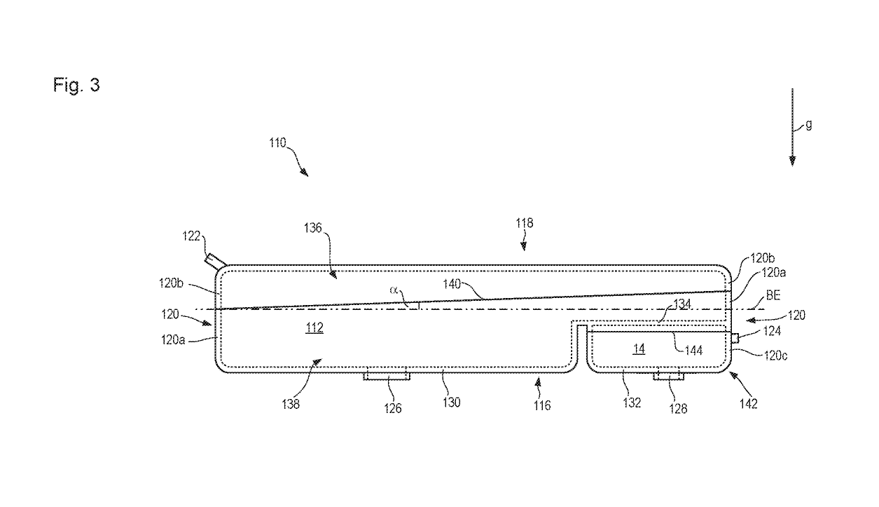

In the second exemplifying embodiment according to FIG. 3, the larger reservoir chamber 112 is embodied with a locally different cross section when viewing a section in a section plane that is orthogonal to the drawing plane of FIG. 1 and parallel to direction of gravity g, so that the smaller reservoir chamber 114 can be arranged below or above a portion of, i.e. at a different geodetic elevation than, the larger reservoir chamber 112 when multi-chamber plastic tank 110 is in the operationally ready installation position.

The second embodiment in FIG. 3 will be explained below only insofar as it differs from the first embodiment of FIGS. 1 and 2, to the description of which the reader is otherwise expressly referred for an explanation of the second embodiment as well.

Identical and functionally identical components and component portions are labeled in the second embodiment with reference characters identical to those of the first embodiment, but incremented by 100.

In contrast to the first exemplifying embodiment, multi-chamber plastic tank 110 of the second exemplifying embodiment encompasses a third tank component 142 in addition to tank components 136 and 138.

Whereas tank component 138 comprises partition 134, which in the second exemplifying embodiment is oriented parallel to reference plane BE, in complete and undivided fashion, tank components 136 and 142 are merely hood-shaped. They thus constitute hood components 136 and 142 as defined in the description above, while tank component 138 is a partition component 138 as defined in the description above. Hood component 136 encompasses the entire tank lid 118. Partition component 138 encompasses, in addition to the entire partition 134, the entire bottom 130 of the larger reservoir chamber 112. Hood component 142 encompasses the entire bottom 132 of the smaller reservoir chamber 114.

Each of tank components 136, 138, and 142 encompasses part of the side walls of multi-chamber plastic tank 110 and of reservoir chambers 112 and 114. Portions of the respective side walls on the individual tank components are again labeled with lower-case letters, specifically a lower-case “a” for partition component 138, a lower-case “b” for hood component 136 of the larger reservoir chamber 112, and a lower-case “c” for hood component 142 of the smaller reservoir chamber 114.

Projecting from partition component 138 in the region of partition 134 on both sides thereof are partition portions 120a that are connected on the one side of partition 134 to hood component 136 and on the other side of partition 134 to hood component 142.

Because multi-chamber plastic tank 110 encompasses three tank components 136, 138, and 142, it has two joining surfaces 140 and 144 embodied mutually independently. Joining surface 140, which again is a joining plane 140, is the joining site at which hood component 136 is connected to partition component 138. Joining surface 144, which is likewise preferably a joining plane 144, is the joining site at which hood component 142 is connected to partition component 138.

In the exemplifying embodiment depicted in FIG. 3, the smaller joining plane 144 is embodied parallel to reference plane BE. The larger joining plane 140, on the other hand, is arranged with an inclination relative to reference plane BE, for example at an angle α of 6°. This inclination value as well is recited merely by way of example, and can deviate from the indicated 6°. For practical reasons, the value of an inclination angle of a joining plane or joining surface relative to reference surface BE is in a range from 5° to 50°.

Because the smaller joining plane 144 is oriented parallel to reference plane BE in the second embodiment, the larger joining plane 140 encloses the same angle α with the smaller joining plane 144 as with reference plane BE. In a departure from what is depicted in FIG. 3, the smaller joining plane 144 can likewise enclose an angle with reference plane BE. That angle can be the same as or different from the angle α between the larger joining plane 140 and reference plane BE.

Plastic tank components 136, 138, and 142 are unmolded from their respective injection molding tools in unmolding directions that are oriented parallel to direction of gravity g. This assumes that the individual tank components 136, 138, and 142 are oriented, as depicted in FIG. 3, in their respective operationally ready installation position. A tank component of course can be, and is, generated in a spatial orientation that deviates from the subsequent installation position. The unmolding direction participates in the same transformation, starting from the direction of gravity, that conveys the respective tank component from the installation position shown in FIG. 3 into its orientation upon manufacture by injection molding. This is also true for the first embodiment of FIGS. 1 and 2.

In the case of joining surfaces 40 and 140 that are inclined with respect to reference plane BE, the unmolding directions of the respective plastic tank components 136, 138, and 142 are inclined relative to the component edges defining the joining surface.

The openings for introducing liquid into the individual reservoir chambers, and for withdrawing liquid from them, are depicted in merely schematic and exemplifying fashion in the exemplifying embodiments. Provision can thus be made to withdraw different liquids from different reservoir chambers at different locations on the respective chamber. For example, fuel can be withdrawn by means of a pump arrangement through an opening in the lid of the respective reservoir chamber, and a reduction liquid can be withdrawn through an opening in the bottom of the associated reservoir chamber, preferably once again using a pump arrangement.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. A multi-chamber plastic tank, in particular for a motor vehicle, encompassing at least two reservoir chambers, the at least two reservoir chambers being fluid-mechanically separated from one another, each of the at least two reservoir chambers being mutually independently fillable with liquid and from each of which liquids stored therein are mutually independently non-mixingly withdrawable, the multi-chamber plastic tank comprising a plurality of injection-molded plastic tank components that are intermaterially connected to one another along at least one joining surface,
wherein with regard to the final operationally ready installation position of the multi-chamber plastic tank, at least one of the at least one joining surface is inclined, relative to a reference plane orthogonal to a direction of gravity, in such a way that it is neither parallel nor orthogonal to the reference plane.

12. The multi-chamber plastic tank according to claim 11, wherein the at least one joining surface is a joining plane.

13. The multi-chamber plastic tank according to claim 11, wherein the at least one joining surface is a plurality of joining surfaces, all of the plurality of joining surfaces are joining planes.

14. The multi-chamber plastic tank according to claim 11, wherein the at least one joining surface is inclined by between 5° and 50° with respect to the reference plane.

15. The multi-chamber plastic tank according to claim 11, wherein the at least one joining surface is inclined by between approximately 5° to 40° with respect to the reference plane.

16. The multi-chamber plastic tank according to claim 11, wherein a partition between two of the at least two reservoir chambers encloses a different angle with the reference plane than the at least one joining surface.

17. The multi-chamber plastic tank according to claim 11, wherein a partition between two of the at least two reservoir chambers encloses a smaller angle with the reference plane than the at least one joining surface.

18. The multi-chamber plastic tank according to claim 17, wherein the partition is parallel to the reference plane.

19. The multi-chamber plastic tank according to claim 11, wherein a partition between two of the at least two reservoir chambers encloses a larger angle with the reference plane than the at least one joining surface.

20. The multi-chamber plastic tank according to claim 19, wherein the partition is orthogonal to the reference plane.

21. The multi-chamber plastic tank according to claim 11, wherein the at least one joining surface is a plurality of joining surfaces, at least two of the plurality of joining surfaces each being inclined with respect to the reference plane in such a way that the at least two joining surfaces are neither parallel nor orthogonal to the reference plane, the at least two joining surfaces extending at an angle relative to one another.

22. The multi-chamber plastic tank according to claim 11, wherein the at least one joining surface is a plurality of joining surfaces, the plurality of joining surfaces including at least two mutually parallel joining surfaces each being inclined with respect to the reference plane in such a way that they are neither parallel nor orthogonal to the reference plane.

23. The multi-chamber plastic tank according to claim 11, wherein the plurality of injection-molded plastic tank components is at least three plastic tank components, of which two plastic tank components are embodied in hood-shaped fashion as hood components, and of which one plastic tank component comprises, as a partition component, a partition separating different reservoir chambers from one another.

24. The multi-chamber plastic tank according to claim 23, wherein the at least three plastic tank components is exactly three plastic tank components.

25. The multi-chamber plastic tank according to claim 23, wherein the partition component comprises the partition and at least one wall portion, projecting from the partition, for connection to at least one of the hood components.

26. The multi-chamber plastic tank according to claim 23, wherein the partition component comprises, on both sides of the partition, a respective wall portion projecting therefrom, each one for connection to a different one of the hood components.

27. The multi-chamber plastic tank according to claim 11, further including a partition between two of the at least two reservoir chambers, the partition extending at a different angle relative to the reference plane than the at least one joining surface.

28. The multi-chamber plastic tank according to claim 27, wherein the different angle is a smaller angle.

29. The multi-chamber plastic tank according to claim 27, wherein the different angle is a larger angle.
